(19) United States
(12) Patent Application Publication
(10) Pub. No.: US 2025/0247827 A1
(43) Pub. Date: Jul. 31, 2025

(54) CHANNEL AND SIGNAL CONTROL FOR AMBIENT IOT SYSTEMS

(71) Applicant: Samsung Electronics Co., Ltd., Suwon-si (KR)

(72) Inventors: Yuhan ZHOU, San Diego, CA (US); Yaser Mohamed Mostafa Kamal FOUAD, San Diego, CA (US); Philippe Jean Marc Michel SARTORI, Naperville, IL (US)

(21) Appl. No.: 19/040,755

(22) Filed: Jan. 29, 2025

Related U.S. Application Data
(60) Provisional application No. 63/626,820, filed on Jan. 30, 2024.

(51) Int. Cl. H04W 72/044; H04W 72/0446; H04W 72/0453

(52) U.S. Cl. CPC H04W 72/044; H04W 72/0446; H04W 72/0453

(57) ABSTRACT

A system, device, and a method are disclosed that may implement the control of aspects of the physical layer, including channels and/or signals, for ambient IoT devices in a manner that may ensure efficient, reliable, and low-power transmission of data. Methods may implement a frame structure and transmission, a control channel structure and function, a wake-up signal structure and transmission, and multiple access schemes for ambient IoT devices. For example, a method includes an ambient Internet of Things (IoT) device receiving an energizing signal, receiving a first signal including a preamble and a data field, that requests a response from the ambient IoT device based on the energizing signal, and in response to the first signal, transmitting a second signal including a preamble, a control channel field, and a data field.

### CROSS-REFERENCE TO RELATED APPLICATION

This application claims the priority benefit under 35 U.S.C. § 119 (e) of U.S. Provisional Application No. 63/626,820, filed on Jan. 30, 2024, the disclosure of which is incorporated by reference in its entirety as if fully set forth herein.

### BACKGROUND

### 1. Field

Aspects of some embodiments of the present disclosure generally relate to wireless communication systems. More particularly, the subject matter disclosed herein relates to improvements to the control of channels and/or signals.

### 2. Description of the Related Art

The physical layer in wireless communication may be utilized for transmitting data over a communication medium. It may define the resources and signaling standards for connecting wireless devices in a wireless network. Therefore, it may be desirable to implement a structure and/or function of resources at the physical layer, including channels and/or signals, in a manner that is suitable and/or optimal for Internet of Things (IoT) systems.

The above information disclosed in this Background section is for enhancement of understanding of the background of the present disclosure, and therefore, it may contain information that does not constitute prior art.

### SUMMARY

Aspects of some embodiments of the present disclosure generally relate to wireless communication systems. For example, aspects of some embodiments of the present disclosure generally relate to improvements to the control of signals and channels.

The utilization of the physical layer resources, including signals and/or channels, in accordance with some wireless communication technology standards, may not consider factors that are relevant to low-power wireless devices, such as IoT devices. Factors that may be impacted by the structure and/or function of resources at the physical layer may include range, power consumption, data rate, and/or the like, which may need to be balanced efficiently to meet the diverse applications of IoT devices. This issue may be exacerbated in the case of ambient IoT systems, which may be ultra-low power and may have low complexity.

Aspects of some embodiments of the present disclosure relate to systems and methods that may control aspects of the physical layer, including channels and/or signals, for ambient IoT devices in a manner that ensures efficient, reliable, and low-power transmission of data. Thus, the disclosed embodiments may improve the efficiency, range, and overall performance of a wireless communication network.

In an embodiment, a method may include receiving, by an ambient Internet of Things (IoT) device, an energizing signal. The ambient IoT device may receive, from a first device, a first signal that requests a response from the ambient IoT device based on the energizing signal. The first signal may include a preamble and a data field. In response to the first signal, the ambient IoT device may transmit a second signal including a preamble, a control channel field, and a data field.

In an embodiment, the first device may include a reader and the energizing signal may include a carrier wave signal.

In an embodiment, the first signal may include a device identifier (ID) of a device or a group ID that maps to multiple devices.

In an embodiment, the control channel field and the data field are transmitted as Time Division Multiplexed.

In an embodiment, the preamble in the first signal and the preamble in the second signal are different.

In an embodiment, the preamble in the second signal may include a sequence based on a data rate of the ambient IoT device.

In an embodiment, the first signal may include time/frequency resource allocation information for the second signal.

In an embodiment, the control channel field in the second signal may include Hybrid Automatic Repeat Request (HARQ) for the second signal.

In an embodiment, a method may include, transmitting, from a device, an energizing signal. The device may receive a first a first signal from the first ambient Internet of Things (IoT) device based on the energizing signal. The device may receive a second signal from a second ambient IoT device, and multiplex the first signal from the first ambient IoT device and the second signal from the second ambient IoT device.

In an embodiment, multiplexing the first signal from the first ambient IoT device and the second signal from the second ambient IoT device may include at least one of: using Time Division Multiple Access (TDMA), using Frequency Division Multiple Access (FDMA), or using Code Division Multiple Access (CDMA).

In an embodiment, multiplexing the first signal from the first ambient IoT device and the second signal from the second ambient IoT device may include using CDMA comprises Hadamard codes to spread the first signal and the second signal.

In an embodiment, the method may include transmitting data encoded with the Hadamard codes using On-Off Keying (OOK) modulation.

In an embodiment, the method may include spreading the first signal from the first ambient IoT device and the second signal from the second ambient IoT device over multiple slots based on a spreading code.

In an embodiment, a device may include one or more processors that are configured to perform receiving, from a reader, an energizing signal. The device may receive, from the reader, a first signal that requests a response from the device based on the energizing signal; and in response to the first signal, transmitting a second signal including a preamble.

In an embodiment, the first signal may include a preamble and a data field.

In an embodiment, the preamble in the first signal is modulated based on On-Off Keying (OOK) and configured for synchronization with a reader.

In an embodiment, the second signal has a structure may include the preamble; a control channel field; and a data field.

In an embodiment, the first signal may include a device identifier (ID) of a device or a group ID that maps to multiple devices.

In an embodiment, the device may be an ambient Internet of Things (IoT) device.

### BRIEF DESCRIPTION OF THE DRAWINGS

In the following section, the aspects of the subject matter disclosed herein will be described with reference to exemplary embodiments illustrated in the figures, in which:

FIG. 1 depicts an example wireless network system configured to channel and/or signal control for ambient Internet of Things (IoT) devices, according to some embodiments.

FIG. 2 is a block diagram depicting an example ambient IoT device implementing a channel and signal control circuit, according to some embodiments of the present disclosure.

FIG. 3A depicts an example of a transmission of frames for an ambient IoT device implementing a channel and signal control circuit, according to some embodiments of the present disclosure.

FIG. 3B depicts another example of a transmission of frames for an ambient IoT device including an inactive period, according to embodiments of the present disclosure.

FIG. 4 depicts an example structure of a frame for an ambient IoT device, according to some embodiments of the present disclosure.

FIG. 5 depicts aspects of an example data transmission for an ambient IoT device, according to some embodiments of the present disclosure.

FIG. 6 is a flowchart illustrating a method for channeling listening for an ambient IoT device, according to some embodiments of the present disclosure.

FIG. 7 illustrates a system including a user equipment (UE) and a base station (gNB) in communications with each other.

FIG. 8 is a block diagram of an electronic device in a network environment, according to some embodiments of the present disclosure.

### DETAILED DESCRIPTION

In the following detailed description, numerous specific details are set forth in order to provide a more thorough understanding of embodiments according to the present disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures (including component diagrams) shown and discussed herein are for illustrative purpose only and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Internet of Things (IoT) has attracted much attention in the realm of wireless communication. More ‘things’ are expected to be interconnected for improving productivity efficiency and increasing comforts of life. Further reduction of size, complexity, and power consumption of IoT devices may enable the deployment of tens or even hundreds of billion IoT devices for various applications and provide added value across the entire value chain. It may not be possible to power all the IoT devices by a battery that may require manual replacement and/or recharging, which can lead to high maintenance cost, serious environmental issues, and even safety hazards for some use cases (e.g., wireless sensor in electric power and petroleum industry). Thus, implementing wireless communication for IoT devices in a manner that utilizes the limited power resources in a an efficient and/or optimal manner may be beneficial.

Due to the wide range of applications for IoT devices and/or technology, there has been an emergence of ambient IoT devices. Ambient IoT devices may be considered as ultra-lower power, reduced complexity and/or having low power consumption in relation to traditional IoT devices. Ambient IoT devices may use lightweight” communication protocols, such as Bluetooth Low Energy (BLE) and/or Narowband IoT (NB-IoT), and complex computational tasks can be offloaded (e.g., to cloud or edge devices), in a manner that reduce internal complexity. Ambient IoT devices are often designed to gather and/or transmit small amounts of data (e.g., temperature, humidity, location, etc.) and thus may be designed to operate with minimal energy requirements, due to the limited computational and communication functionality of such devices. For example, there may some ambient IoT devices that are “battery free”, where the devices may utilize energy harvesting technologies for power. Thus, ambient IoT devices may be suitable for long-term deployments without the need for frequent battery maintenance and/or replacement, however conservation of power and/or reduced complexity during operation may be significant for ambient IoT devices.

Given the low power and/or low complexity of ambient IoT device, the structure and function of signals and channels utilized for wireless communication in accordance with some wireless technology standards (e.g., 5G NR) may not be suitable and/or optimal for ambient IoT devices. Therefore, it may be important to develop signal design and/or control, and channel structures that are suitable and/or optimal for the capabilities of ambient IoT devices, including achieving efficient and low-power wireless communication. Embodiments of the present disclosure may include systems and methods that may control aspects of the physical layer, including channels and/or signals, for ambient IoT devices in a manner that ensures efficient, reliable, and low-power transmission of data. Thus, the disclosed embodiments may improve the efficiency, range, and overall performance of a wireless communication network.

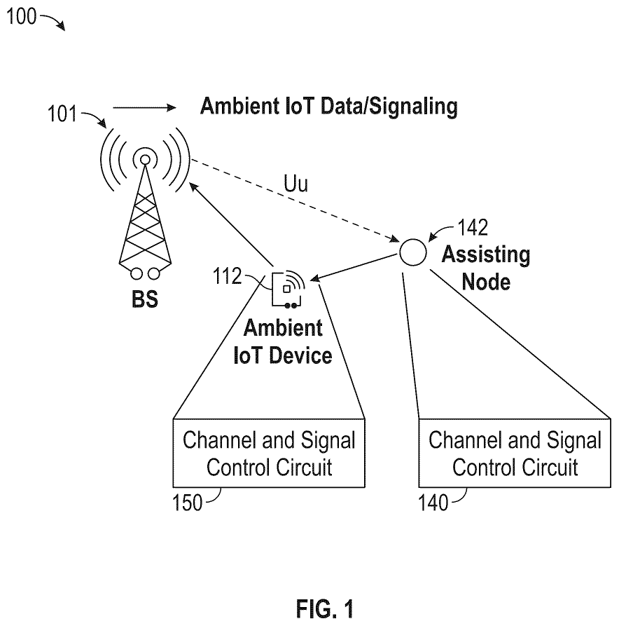

FIG. 1 depicts an example wireless network system 100 configured to implement random resource allocation for ambient IoT devices, according to some embodiments.

As illustrated in FIG. 1, the wireless network 100 may include a base station (BS) also referred to herein as general Nodes B (gNB), shown as a gNB 101. The gNB 101 may also communicate with at least one Internet Protocol (IP) network, such as the Internet, a proprietary IP network, or other data network. Instead of gNB, a component may also be referred to herein as an enhanced Node B (eNB). Depending on the network type, other terms can be used instead of gNB or BS, such as “access point” and/or the like. As used herein, “gNB” may refer to a network infrastructure component that provide wireless access to remote terminals.

Also, the wireless network 100 may include an ambient Internet of Things (IoT) device 112 in communication with the gNB 101. As used herein, an “ambient IoT device” may refer to a low power, wirelessly connectable device that that may operate in a background (ambient environment), collecting and transmitting data autonomously (e.g., without requiring direct user interaction). The ambient IoT device 112 may be energy-efficient, and battery-less, using energy harvesting technique for power from ambient sources including radio waves, light, and/or temperature changes. The ambient IoT device 112 may have the capability to operate autonomously for a long time period, and may be embedded in objects such as labels, packaging, sensors, wearables, and/or the like; and may be configured for various wireless applications such as smart packing, asset tracking, smart homes and building, wearables (e.g., health monitoring devices), and/or the like. The wireless network 100, in some cases, may include a substantially large number of ambient IoT devices, such as ambient IoT device 112 that are deployed in the field. Hence, ambient IoT devices may be cheaper than narrowband IoT devices and may be simpler than NB-IoT. In some cases, ambient IoT devices, such as ambient IoT device may be categorized by a device type according to factors including energy storage capacity, RF signals generation, transmissions, and/or the like. The device types for ambient IoT devices, in accordance with a wireless communication technology standard, may include: device type A having no energy storage, no independent signal generation/amplification (e.g., backscattering transmission); device type B having energy storage, no independent signal generation (e.g., backscattering transmission), and use of stored energy can include amplification for reflected signals; and device type C having energy storage, independent signal generation (e.g., active RF components for transmission).

The ambient IoT device 112 may be configured to operate in different environments (e.g., outdoor and indoor) and may support a wide range of communication distances (e.g., large distances for outdoor and small distances for indoor applications). Accordingly, wireless network 100 may support various communication topologies in accordance with a wireless communication technology standard (e.g., 3GPP) to enable the ambient IoT device 112 to communicate within the network 100. In some embodiments, the ambient IoT device 112 may directly communicate with the gNB 101 as a source. The communication between the ambient IoT device 112 and the gNB 101 may be bidirectional and direct (e.g., with no assistance node in between).

FIG. 1 illustrates an intermediate node 142 that may facilitate the communication between an ambient IoT device 112 and the gNB 101. The intermediate node 142 (e.g., assisting node) may be implement as a wireless component including a user equipment (UE), a relay, a repeater, a reader, gNB, and/or the like. The communication between the ambient IoT device 112 and the intermediate node 142 may be bidirectional. In some embodiments, the communication with the intermediate node 142 may not be bidirectional. For example, in case of uplink (UL) transmission assistance, the ambient IoT device 110 may receive a downlink (DL) communication directly from the gNB 101 while sending the UL communication through the intermediate node 142. In some embodiments, the ambient IoT device 112 may be able to support bidirectional communication directly between the intermediate node 142 (e.g., with no base station involvement), for example a UE.

The gNB 101 may implement a transmit (TX) path that is analogous to transmitting in the downlink (DL) to the ambient IoT device 112 and/or the intermediate node 142, and may implement a receive (RX) path that is analogous to receiving in the uplink from ambient IoT device 112 and/or the intermediate node 142. In an operational example, the gNB 101 may perform DL transmissions to the ambient IoT device 112 in a coverage area. For example, DL transmission from the gNB 101 may involve transmitting data and/or control signals to be received by the ambient IoT device 112 over a wireless channel, in accordance with one or more wireless communication protocols. DL communication may be utilized for delivering data and/or control signals from the network (e.g., gNB) to the ambient IoT device 112 to support several services and/or applications for ambient IoT devices.

The ambient IoT device 112 may implement the TX path for transmitting in the uplink (UL) to the gNB 101 and may implement the RX path for receiving in the DL from the gNB 101. In another operational example, the ambient IoT device 112 may be in the coverage area of the gNB 101 and may perform UL transmissions to the gNB 101. As an example, an UL transmission from the ambient IoT device 112 may involve transmitting data and/or control signals to be received by the gNB 101 over a wireless channel in accordance with one or more wireless communication protocols. The UL communication may be utilized for transmitting data, for example, and maintaining the connections with the gNBs 101-103 through signaling and feedback.

In some real-world applications for ambient IoT devices, the wireless network 100 may include large numbers of low complexity devices (e.g., IoT devices, ambient IoT device, etc.) that may attempt to simultaneously communicate. For example, there may be a plurality of ambient IoT devices that may be located physically proximate to the ambient IoT device 112 in the wireless network 100. Many of these nearby ambient IoT devices may attempt to perform UL transmissions, to the gNB 101 for example, at the same time as the ambient IoT device 112. Given the limited capabilities and the strict energy constraints of these devices, it may be desirable to utilize signals and/or channels in the wireless communication for ambient IoT devices in a manner that can limit computational complexity and reduced overall power consumption.

To address these issues, the ambient IoT device 112 may be configured to implement channel and/or signal control functions that may minimize complexity, power usage, and potential collisions during transmissions, and may improve the overall reliability and/or performance of the wireless network 100. In some embodiments, the ambient IoT device 112 may include circuitry, programing, or a combination thereof for implementing the capabilities and/or functions related to signal control and channel structure, as disclosed herein. In some embodiments, the intermediate node 142 may include circuitry, programing, or a combination for implementing the capabilities and/or functions related to channel and/or signal control functions, as disclosed herein.

For example, FIG. 1 depicts that the intermediate node 142 may be configured with a channel and signal control circuit 140, which enables intermediate node 142 to execute the capabilities and/or functions for channel and/or signal control, as disclosed in greater detail herein; and ambient IoT device 12 may implement a channel and signal control circuit 150 which enables the ambient IoT device 112 to execute the capabilities and/or functions for channel and/or signal control, as disclosed in greater detail herein. For example, channel and signal control circuits 140, 150 may be configured to control aspects of the physical layer, including the structure of channels and/or signals, for ambient IoT devices.

In some embodiments, the channel and signal control circuits 140, 150 may be configured to implement several capabilities and/or functions including, but not limited to: implementing a frame structure and transmission; implementing a control channel structure and function; implementing a wake-up signal structure and transmission; and implementing multiple access schemes for ambient IoT devices, as disclosed herein. It should be understood that the channel and signal control functions, according to the disclosed embodiments, are not limited to ambient IoT devices and may be applicable to other types of low-power wireless devices, including but not limited to: passive and/or low-energy communication devices; environmentally-integrated network devices; autonomous low-power electronic devices; distributed network-enabled devices; and/or the like, without departing from the scope.

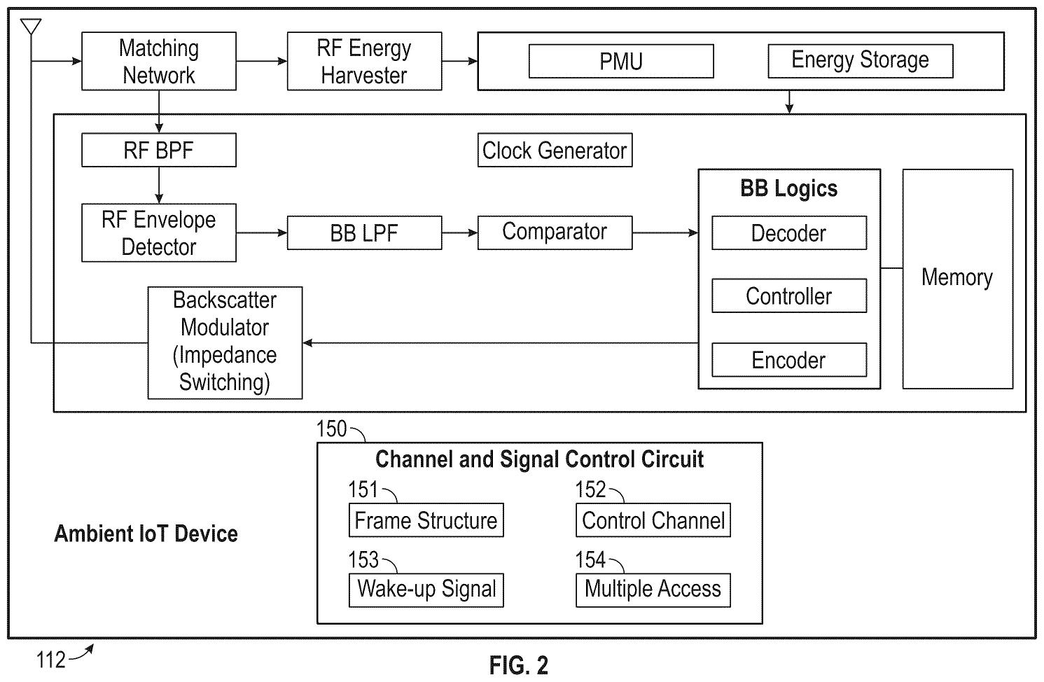

FIG. 2 is a block diagram depicting an example ambient IoT device 112 implementing a channel and signal control circuit 150 for supporting enhanced channel and signal functions for ambient IoT devices, according to some embodiments of the present disclosure.

As illustrated in FIG. 2, an example configuration of the ambient IoT 112 (e.g., see FIG. 1) can include multiple hardware and/or software components implementing capabilities of an ambient IoT device, including energy storage, backscattering transmission, and/or the like. Each of the hardware and/or software components in the example configuration for the ambient IoT 112 are not described in detail herein for brevity, and can operate in accordance with some wireless communication technology standards without departing from the scope of the invention. Additionally, the example configuration of the ambient IoT device 112 is not intended to be limiting to the embodiments disclosed herein, and hardware and/or software components may (or may not) be implemented in the architecture as deemed optimal and/or suitable.

FIG. 2 depicts an example configuration of the ambient IoT device 112 (e.g., see FIG. 1) that can include multiple hardware and/or software components implementing capabilities related to channel and signal control functions. The ambient IoT device 112 depicted in FIG. 2 is not intended to be limiting, and the related structure and/or functions of the components may be implemented in a wide variety of configurations, without departing from the scope of this disclosure. In some embodiments, the ambient IoT device 112 may be configured to implement the functions related to channel and signal control that are performed on the UE side, as disclosed herein.

Additionally, in some embodiments, a source (e.g., gNB 101 shown in FIG. 1) may be configured with similar hardware and/or software components to implement the capabilities related to random resource allocation and/or selection, as described in reference to FIG. 2. In some embodiments, the source may be configured to implement the functions related to random resource allocation that are performed on the network side, as disclosed herein. In some embodiments, the ambient IoT device 112 including the channel and signal control circuit 150 may be configured to implement functions in addition to and/or in lieu of the functions of the source (e.g., network side) without departing from the scope of the disclose embodiments.

In some embodiments, the ambient IoT device 112 may include a channel and signal control circuit 150 that may be configured to implement control of the channels and signals utilized for ambient IoT devices. In the example of FIG. 2, the channel and signal control circuit 150 may be configured to include circuitry executing the disclosed channel and signal functions and procedures, the circuitry including: frame circuitry 151; control channel circuitry 152; wake-up signal circuitry 153; and multiple access circuitry 154.

The frame circuitry 151 may be configured to implement a frame, and transmission thereof, that is structured to be optimal for ambient IoT devices. The frame circuitry 151 may generate frames having a set (e.g., defined) structure and transmit those frames using a frame burst technique that is arranged for communication involving ambient IoT devices, such as ambient IoT device 112. As used herein, a “frame burst” may refer to transmitting multiple data frames in rapid succession without waiting for an acknowledgement (ACK) after each frame. As used herein, a “frame” may refer to a data unit that may be structured and communicated in accordance with a protocol for wirelessly transmitting information, including sensor readings, commands, and/or status updates. In some embodiments, the format of the frame burst is configured by the gNB 101, which may be bounded by a wake-up signal (e.g., a frame burst occurs within the duration of transmitting wake-up signal) that is sent by the gNB 101. The frame burst may include a set number (X) of frames of a set duration (e.g., equal duration). In some embodiments, the set number of frames (X) may be a fixed value that is configured by the gNB 101. The ambient IoT device 112 may be configured by the gNB 101 to have an active period and/or an inactive period within the frame burst, which may be subject to the capability of the ambient IoT device 112. The active and/or inactive periods of the frame burst may be configured for a specific (e.g., individual) ambient IoT device and/or a group of ambient IoT devices (e.g., ambient IoT devices of same device type). The information for active and/or inactive periods may be conveyed to the ambient IoT device 112 through system information and/or radio resource control (RRC). Some of the information for active and/or inactive periods may be included in the content of the wake-up signal. During the inactive period of a frame burst, the frame circuitry 151 may enable the ambient IoT device 112 to enter a low-power mode, in which the ambient IoT device 112 may not monitor the channel. The wake-up signal transmission may start at the beginning of the first frame of each frame burst, when the frame circuitry 151 may enable the the IoT device 112 to enter a power mode to monitor the channel in preparation of the communication of frames. The transmission of the frame burst may be disabled by gNB 101 by turning off (e.g., stopping) the wake-up signal transmission. If the transmission of the frame burst is disabled, the frame circuitry 151 may enable the low-power mode of the ambient IoT 112 device, which allows the ambient IoT 112 device to not monitor the channel for frames (e.g., monitors the channel for wake-up signal only) when the frame burst is not in transmission.

The frame circuitry 151 may be configured to implement a defined wake-up signal slot and a defined regular slot that are utilized in the frame burst functions. The wake-up signal slot may be defined (e.g., pre-configured) by RRC scheduling, and may be periodically transmitted. During a wake-up signal slot, the gNB 101 (and/or UE) can transmit a wake-up signal for one or more ambient IoT devices, such as ambient IoT device 112. If the ambient IoT device 112 receives a corresponding wake-up signal (e.g., wake-up signal that is configured to activate that device), the frame circuitry 151 may enable the ambient IoT device to enter the active period of the frame burst for a set number (X) of slots. If the ambient IoT device 112 does not received a corresponding wake-up signal (e.g., no wake-up signal, wake-up signal configured to activate other devices, etc.), the frame circuitry 151 may enable the ambient IoT device 112 to re-enter a low-power mode (e.g., inactive mode) and/or not monitor the channel for frames (e.g., monitoring the channel only for another wake-up signal). In some embodiments, the wake-up signal slots may be configured to be aperiodic. During an inactive period of a frame burst, the frame circuitry 151 may enable the ambient IoT device 112 to monitor the channel for a wake-up signal. During an active period of a frame burst, the frame circuitry 151 may enable the ambient IoT device 112 to monitor the channel. A regular slot may be a defined slot for enabling the ambient IoT device 112 to monitor the channel and/or transmit data.

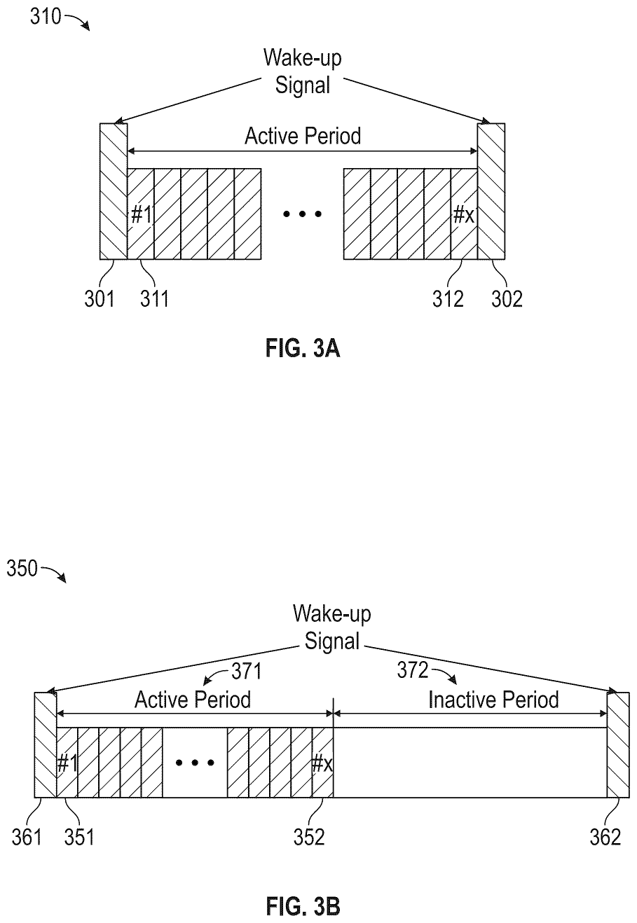

FIG. 3A depicts an example of transmission of a frame burst 310 that may be implemented by the frame circuitry 151 for communication with the ambient IoT device 112. In FIG. 3A, the frame burst 310 includes an active period. For example, a gNB 101 may transmit a wake-up signal to the ambient IoT device 112 within a wake-up slot 301. Subsequently, after the initial wake-up signal slot 301, the frame burst 310 may begin. In some embodiments, the wake-up signal that is transmitted in the wake-up slot 301 may include an indication to the ambient IoT device 112 that an active period is included in the frame burst 310 for a DL. Accordingly, the powered-up (e.g., awake) ambient IoT device 112 may be set to an active mode in order to monitor the channel during the active period of the frame burst 310. The frame burst 310 depicted in FIG. 3A may be configured to include a defined number (X) of frames, beginning with a first frame 311 (e.g., frame #1) and ending with a last frame 312 (e.g., frame #X). The frames 311-312 in the frame burst 310 may be transmitted to the ambient IoT device 112 in continuous succession while the ambient IoT device is in an active-mode and actively monitoring the channel for frames (within the duration of the active period). For example, the first frame 311 may include data that is transmitted to the ambient IoT device 112 by a DL signal in a regular slot. FIG. 3A illustrates that the active period may last for the entire duration of the frame burst 310, which may allow for communication of frames with the ambient IoT device 112 throughout the frame burst 310. The gNB 101 may stop transmitting the wake-up signal at the end of a wake-up slot 302, which then ends the transmission of the frame burst 310.

FIG. 3B depicts another example of transmission of a frame burst 350 that may be implemented by the frame circuitry 151 for communication with the ambient IoT device 112. In the example of FIG. 3B, the frame burst 350 includes an active period 371 and an inactive period 372. The gNB 101 may transmit a wake-up signal to the ambient IoT device 112 at wake-up slot 361, and then start transmission of the frame burst 350.

In some embodiments, the wake-up signal may indicate to the ambient IoT device 112 that an active period 371 and an inactive period 372 are included in the frame burst 350 and may indicate the respective durations for each period (e.g., number of slots/frames corresponding to a period). During the active period 371, the ambient IoT device 112 may be set to an active mode and monitors the channel for the transmission frames in frame burst 350. After the wake-up slot 361, the transmission of the frames in the frame burst 350 may begin by transmitting a first frame 351 (e.g., frame #1) in a regular slot, where the subsequent frames of the frame burst 350 are consecutively transmitted and ending with a last frame 312 (e.g., frame #X).

After the defined number (X) of frames for the frame burst 350 have been transmitted, the inactive period 372 of the frame burst may start. For the duration of the inactive period, the ambient IoT device 112 may switch to an inactive (e.g., low power) mode, where the ambient IoT device does not monitor the channel for the communication of frames. After the inactive period 372, the gNB 101 may stop transmission of the wake-up signal ending at wake-up slot 302, which then ends the frame burst 350. Thus, FIG. 3B illustrates that the frame burst technique for ambient IoT devices, as disclosed herein, utilizes active and/or inactive periods in a manner that may reduce the overall power consumption and optimize the limited power resources of ambient IoT devices for wireless communication.

Referring back to FIG. 2, the frame circuitry 151 may be configured to utilize frames having a structure that can be suitable and/or optimal for the capabilities of ambient IoT devices. For example, the frame circuitry 151 may implement the aforementioned frame burst technique utilizing a frame that is particularly structured to include a preamble that proceeds the data and/or control units of the frame. A frame that may be communicated to and/or from ambient IoT devices, at a regular slot for example, may have a structure that is different from a frame structured in accordance with some wireless communication technology standards (e.g., NR). An ambient IoT devices may utilize data channels and control channels that are particularly structured and/or controlled for use by these devices, as disclosed herein. Data may be transmitted in the DL, UL, and/or sidelink (SL) channels for ambient IoT devices. Thus, frame circuitry 151 may implement a frame that is structured to be suitable and/or optimal for use with these channels and functions of ambient IoT devices.

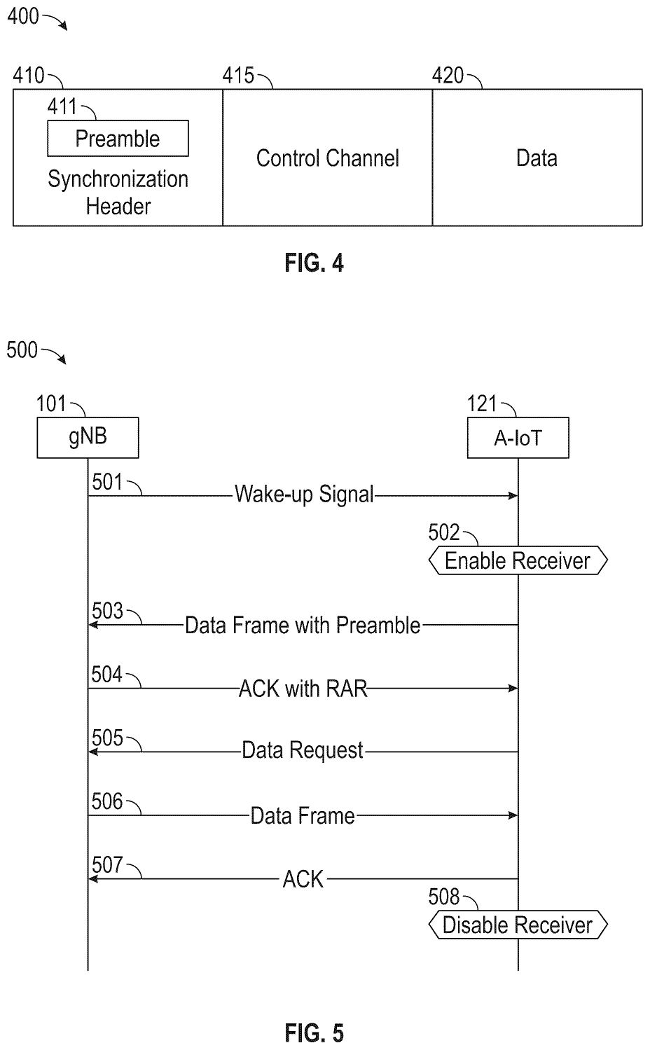

FIG. 4 depicts an example format of a frame 400 that may be utilized by the frame circuitry 151 for communication to and/or from the ambient IoT device 112, for instance during a frame burst transmission. The frame 400 may have a format having one or more fields that include a synchronization header field 410, control channel field 415, and data field 420. In some embodiments, an ambient IoT device may be designed to utilize a 15 KHZ sub-carrier spacings (SCS), different modulation technique including On-Off keying (OOK), Frequency Shift Keying (FSK), and/or Quadrature Phase Shift Keying (QPSK), and a relatively small bandwidth (e.g., 5 MHZ) in comparison to some wireless communication technology standards (e.g., LTE, NR, etc.) in order to support wireless communication. Accordingly, the structure of the frame 400 may be suitable and/or optimal for such low-power and/or low-bandwidth wireless communication for ambient IoT devices.

The synchronization header field 410 may include a preamble 411. The preamble 411 may be used for synchronization with gNB 101 and an ambient IoT device 112. The preamble 411 may have a sequence that is configured based on the data rate as described in Table 2.

TABLE 1

| Data rate | Preamble sequence |
|---|---|
| X ≥ [5] kbps | Preamble Sequence #1 |
| Y ≥ [0.1] kbps | Preamble Sequence #1 |

In some embodiments, a different preamble 411 may be used and/or configured based on the data rate, because devices utilizing a relatively low data rate may have different (e.g., less stringent) synchronization requirements than devices utilizing a higher data rate. The duration of the synchronization header 410 (in unit of slots) may be configured through system information or RRC signaling. The synchronization sequence included in the synchronization header 410 may be used to indicate the source (e.g., sequence X used to indicate gNB, sequence Y is used to indicate intermediate node (e.g., legacy UE), etc.). In some embodiments, a set of sequences may be utilized to indicate multiple sources (e.g., an intermediate node) such that the ambient IoT device 112 may distinguish between adjacent nodes.

Referring again to FIG. 2, the control channel circuitry 152 may be configured to implement a control channel utilizing waveforms and modulations that may be suitable and/or optimal for communication to and/or from the ambient IoT device 112. For example, the control channel circuitry 152 may implement a control channel that utilizes modulation schemes and/or waveforms, such as Orthogonal Frequency Division Multiplexing (OFDM), to support transmission (e.g., reader-to-device) to and/or from the ambient IoT device 112. The control channel circuitry 152 may also implement a control channel that includes resource allocation information (e.g., time/frequency resource allocation information) for the data.

In some embodiments, the DL control information (DCI) for ambient IoT device 112 may include the scheduling of the DL transmission (e.g., the resource allocation for DL data), and the scheduling of the UL transmission (e.g., the resource allocation for UL data). The UL control information (UCI) for the ambient IoT device 112 may include: Hybrid Automatic Repeat Request (HARQ) data; scheduling request (SR) data; and an indicator which may inform the gNB if the ambient IoT device enters energizing mode (e.g., ambient IoT device will recharge itself). The SL control information (SCI) for the ambient IoT device 112 may include: source identifier (ID); destination ID; HARQ feedback indicator; resource allocation information in time and frequency domain; a Demodulation Reference Signal (DMRS) pattern; a resource reservation period; and a modulation and coding scheme. The control channel circuitry 152 may be configured to utilize waveforms and modulation schemes for the control channel that may include: OFDM; OOK; FSK; and/or the like. For example, if the ambient IoT device 112 is detected to lack power, the control channel circuitry 152 may utilize the control channel to inform the network that it will enter energizing mode by using the indication field in the UCI and/or the Medium Access Control (MAC) Control Element (CE). In the energizing mode, the ambient IoT device 112 may be able to recharge, for example by absorbing the energy through sources (e.g., electromagnetic waves, solar, etc.). Thus, the control channel circuitry 152 implements a control channel that is optimal for the functions and/or capabilities of ambient IoT devices, including low-power wireless communication.

In the frequency domain, the control channel implemented by the control channel circuitry 152 may occupy one or more control subchannels. Each control subchannel may include one or more consecutive physical resource blocks (PRBs) in frequency. The frequency location information for the control channels may be configured by the gNB 101, and then may be conveyed to the ambient IoT device 112 through system information and/or RRC.

In the time domain, the control channel implemented by the control channel circuitry 152 may occur in set (e.g., specific) slots. In some embodiments, the time offset between the wake-up signal and the control channel may be configured by the gNB 101. In the slot that may include the control channel information, the number of symbols for control signaling may be set (e.g., fixed) and configured by the gNB 101. In some embodiments, across slot scheduling may be supported (e.g., the control symbols carry the resource allocation information of data symbols in more than one slots). The control symbols may not be present in each slot, and the slots containing control symbols may be set (e.g., pre-defined) in a table, for example, and/or configured by the gNB 101 through RRC signaling and/or system information.

In some embodiments, the control channel may be implemented by the control channel circuitry 152 by utilizing (e.g., simplifying) the Physical Downlink Control Channel (PDCCH) for DL transmission, the Physical Uplink Control Channel (PUCCH) for UL transmission, and the Physical Sidelink Control Channel (PSCCH) for SL transmission in accordance with some wireless communication technology standards. The control channel circuitry 152 may implement the resource allocation of control channel based on the communication topology. For example, in a communication topology where the ambient IoT device 112 may be directly connected with the gNB 101, the control channel circuitry 152 may implement the control signal by utilizing a signal (e.g., PDCCH) and modifying: the number of CORESETs per BWP to be 1 or 2; in time domain a CORESET set to be up to 2 OFDM symbols in duration and located at the beginning of a slot; the CCE-to-REG mapping set to be only non-interleaved, and/or the CCE-to-REG mapping can be interleaved or non-interleaved with a set REG bundle size (e.g., 6) for interleaved and/or non-interleaved cases (shown in Table 2 below); the number of aggregation level set to be 1, 2, where the PDCCH may consist of one or more CCEs for ambient IoT devices (shown in Table 2); and the value of a RRC parameter (nrofCandidates) in IE (SearchSpace) can be set to a value from {0, 1, 2, 3, 4} for each aggregation level {1, 2, 4, 8, 16} for power saving.

| Aggregation level | Number of CCEs |
|---|---|
| 1 | 1 |
| 2 | 2 |

In a communication topology where the ambient IoT device 112 may be connected to an intermediate node (e.g., UE 142), the control channel circuitry 152 may implement the control signal by utilizing a signal (e.g., PSCCH) and modifying: the first-stage SCI to be supported; and sensing and resource selection (and/or reselection) to be enabled for an ambient IoT device of a specific type, based on the capability of the ambient IoT device.

In some embodiments, the control channel circuitry 152 may be configured to implement and/or control the processing time for synchronization, control, and data (e.g., frame) related to the control signal. For example, if the ambient IoT device 112 may be triggered to detect the synchronization header signal, the ambient IoT device 112 may be controlled to receive the synchronization header signal at a set number of time slots (To) after the reception of the wake-up signal. In the case when the ambient IoT device 112 may be triggered to detect the control signal, the ambient IoT device 112 may be controlled to receive the control signal at a set number of time slots (T₁) after the reception of the wake-up signal. In the case when the ambient IoT device 112 is scheduled to receive DL data, the ambient IoT device 112 may be controlled to receive the DL data signal at a set number of time slots (T₂) after the reception of the control signal. In the case when the ambient IoT device 112 may be scheduled to transmit UL data, the ambient IoT device 112 may be controlled to transmit the UL data signal at a set number of time slots (T₃) after the reception of the control signal. Thus, the control channel circuitry 152 may implement a control channel that is structured to be suitable and/or optimal for the capabilities of ambient IoT devices, including achieving efficient and low-power wireless communication.

The wake-up signal circuitry 153 may be configured to implement a wake-up signal and related functions that may be suitable and/or optimal for communication to and/or from the ambient IoT device 112. As used herein, the term “wake-up signal” may refer to a signal and/or trigger used to transition a device from a low-power (e.g., sleep, idle, inactive, etc.) state to an active state (e.g., awake, powered, performing functions, etc.). Ambient IoT devices may be designed to conserve energy by spending a substantial amount of time in low-power modes, and “waking-up” when specific conditions are met. The wake-up signal may enable the transition of the ambient IoT device 112 from the low-power mode to low-power state to the active state efficiently. The wake-up signal (WUS) is a crucial design for power saving for A-IoT devices. In some embodiments, the modulation scheme and/or waveform of wake-up signal implemented by the wake-up signal circuitry 153 may include at least one of: OOK; FSK; OFDM; and/or the like.

The wake-up signal circuitry 153 may implement the wake-up signal to include information that may be pertinent to the function and/or capabilities of ambient IoT devices. In an embodiment, the wake-up signal may include information that can be carried by pseudo-random sequences and/or low Peak-to-Average-Power Ratio (PARP) sequences (e.g., Zadoff-Chu sequence). In some embodiments, the wake-up signal may include information that can be carried by encoded bits. Line codes such as unipolar, polar, bipolar, Manchester code, and/or the like may be used by the wake-up signal circuitry 153 for encoding information into the wake-up signal. The wake-up signal circuitry 153 may implement the wake-up signal to carry information that includes, but is not limited to: resource ID; sequence ID; source ID; ambient IoT device ID (e.g., device ID); group ID (or sub-group ID) for mapping to multiple ambient IoT devices; cell information; and/or the like.

The wake-up signal may occupy a set number (X) of symbols (e.g., consecutively) in the time domain and a set number (Y) of subcarriers (e.g., PRBs and/or Hz) (e.g., consecutively) in the frequency domain. The location of the wake-up signal in the frequency domain may be configured by RRC and/or system information. The wake-up signal may be configured as a periodic signal, aperiodic signal, and/or semi-periodic signal in the time domain. The configuration for the wake-up signal may be transmitted through system information and/or RRC from the gNB 101 to the ambient IoT device 112. In some embodiments, the wake-up signal may be configured to operate in an “ON” state and/or an “OFF” state, in which the wake-up signal may be transmitted ON or OFF alternatively. In some embodiments, the wake-up signal may operate in an “ALL ON” state, in which the wake-up signal may be transmitted continuously for a set (e.g., fixed) period. The wake-up signal may have a corresponding preamble. This enables the ambient IoT device 112 to recognize the transmission of the wake-up signal. In some embodiments, the wake-up signal circuitry 153 may effectuate transmission of an energizing signal (e.g., carrier wave signal) with the wake-up signal in a manner that may reduce power consumption for the ambient IoT devices, further optimizing use of its limited resources. The wake-up signal circuitry 153 may implement set (e.g., defined) configurations for one or more wake-up signal resource sets, which may be indicated by the higher layer. Each wake-up signal resource set may include a defined number (K) of wake-up signal resource(s), where each resource may have an associated spatial transmission filter.

The wake-up signal circuitry 153 may be configured to execute wake-up signal detection functions associated with the configured wake-up signal. For example, the wake-up signal circuitry 153 may be configured to measure one or more values to perform wake-up signal detection, the values including but not limited to: WUS−RSSI (Received Signal Strength Indicator) or energy detection, which may be a linear average of total received power over a RSSI resource (e.g., a symbol); WUS−RSRP (Reference Signal Received Power), which may be a linear average of received power of resource of WUS signal(s) and/or signal(s) parts; WUS−SINR (Signal to Interference and Noise Ratio)=WUS−RSRP/(power of interference and noise), where power of interference and noise may be defined as WUS−RSSI subtracts WUS−RSRP; and WUS−RSRQ (Reference Signal Received Quality)=[N×]WUS−RSRP/WUS−RSSI, where N may refer to the factor of resource size difference for evaluation WUS−RSRP and WUS−RSSI. Thus, the ambient IoT device 112 may have the capability to detect the transmission of the wake-up signal on a channel that it is monitoring.

FIG. 5 illustrates an example communication procedure 500 between the gNB 101 and the ambient IoT device 112, including the transmission of a wake-up signal. The data procedure 500 may include a transmission, reception, and acknowledgment process. Although FIG. 5 illustrates various operations in a communication procedure according to some embodiments, embodiments according to the present disclosure are not limited thereto, and according to some embodiments, the procedure may include additional operations, or fewer operations, or the order of operations may vary, unless otherwise stated or implied, without departing from the spirit and scope of embodiments according to the present disclosure.

Operation 501 may involve the gNB 101 transmitting a wake-up signal to the ambient IoT device 112. In response to detecting the wake-up signal, the ambient IoT device 112 may be triggered to enter an active state and enable the receiver at operation 502.

In some embodiments, the ambient IoT device 112 may receive information from the higher layers (e.g., prior to initiating a random-access procedure), where the information may include but is not limited to: configuration of random-access channel transmission parameters; parameters for the random-access preamble sequence set; and/or the like. If a random-access procedure may be initiated by a DL control order to the ambient IoT device 112, a random-access transmission may be with a same SCS as a PRACH transmission that is initiated by the higher layers. The preamble transmission may be configured by the gNB 101 through system information and/or RRC. The random-access procedure for an ambient IoT device 112 may be triggered upon request of a random-access transmission by higher layers and/or by a control channel from a gNB 101. A configuration by higher layers for a random-access transmission may include, at least, the following: a configuration for the random-access transmission on the cell; a preamble index, a preamble SCS, and a random-access resource for the cell; a number of preamble repetitions for the random-access transmission if the ambient IoT device transmits the random access with repetitions.

Operation 503 may involve the ambient IoT device 112 transmitting a data frame with a preamble to the gNB 101. For a random-access transmission by the ambient IoT device 112 that may be triggered by a DL control order, the random-access may be transmitted after a determined slot (e.g., slot n+ T_{offset}, where n is the slot when DL control order is received, and T_{offset} is the time offset between control channel reception and random access transmission, which is configured to the A-IoT device by RRC).

For a random-access transmission that may be triggered by higher layers, the ambient IoT device 112 may be indicated by the network if the random-access occasions are transmitted using the Tx beam (or spatial filter) as one or more wake-up signal transmissions. The random-access occasions may be mapped (e.g., consecutively) per corresponding wake-up signal index. The association between the one or more wake-up signal occasions and a subset of preambles (and/or a subset of random-access resources) may be conveyed to the ambient IoT device 112 through broadcast system information.

For a random-access transmission with preamble repetitions, a set may include valid random-access occasions that are consecutive in time, use same frequency resources, and/or are associated with same one or more wake-up signal index(es), and each wake-up signal block index may be associated with same preamble indexes in all valid random access occasions within the set. The preamble for the random access may be generated using Zadoff-Chu sequence with one or more sequence lengths.

Operation 504 may involve the gNB 101 transmitting an ACK with RAR to the ambient IoT device 112, in response to receiving the data frame with preamble (in previous operation 503). If the ambient IoT device 112 receives the ACK frame from the gNB 101 indicating that the gNB 101 may have a pending data transmission, the ambient IoT device 112 may send a data request command to the gNB 101 and wait for the corresponding data frame from the gNB 101. The Random-Access Response (RAR) UL may schedule a UL transmission for a data request from the ambient IoT device 112. An example of contents of the RAR UL grant (starting with the MSB and ending with the LSB) are shown in Table 4.

TABLE 4

| RAR grant field | Number of bits |
|---|---|
| frequency resource | 12, for operation with shared |
| allocation for UL | spectrum channel access in FR1 or |
| transmission | for FR2-2 when ChannelAccessMode2- |
| | r17 is provided |
| | 14, otherwise |
| time resource allocation for | 4 |
| UL transmission | |
| Power control information | 3 |
| for UL transmission | |

Operation 505 may involve the ambient IoT device 112 transmitting the data request to the gNB 101 in the UL transmission. In response to receiving the data request, operation 506 may involve the gNB 101 transmitting a data frame to the ambient IoT device.

Operation 507 may involve the ambient IoT device 112 transmitting an ACK back to the gNB 101, in response to successfully receiving the data frame from the gNB 101 (in the previous operation 506). If the ACK frame is not received (as expected), retransmission may be performed. If, after sending the ACK frame with the pending frames, the data request command is not received by the gNB 101 from the ambient IoT device 112, the gNB 101 may wait for a retransmission.

In some embodiments, the ambient IoT device 112 may be configured to enter the low-power mode by disabling the monitoring of DL control channel after the DL data reception and/or UL data transmission. Operation 508 may involve the ambient IoT device transitioning from the active mode to the low-power mode (e.g., inactive mode) and disabling the receiver. The ambient IoT device 112 may be scheduled to send a special ACK slot to the gNB 101 to indicate that it will enter low-power mode. The ambient IoT device 112 may disable the monitoring of DL control channel if it does not detect any DL control channel within a set number (TLowPoweroffset) of slots after the transmission of the ACK slot.

The wake-up signal circuitry 153 may be configured to implement a wake-up signal detection procedure that may involve channel listening functions. For example, while in a channel listening mode, the ambient IoT device 112 may be configured to perform a channel monitoring for a time period (e.g., every maxClmPeriod time) which may be set (e.g., pre-configured) by the higher layer and/or the network. The channel monitoring functions may be based on the RSRP measurement of the WUS and/or the RSSI measurement of the received signals from the channel. In some embodiments, the duration of the wake-up signal may be based on a threshold time period (e.g., no less than maxClmPeriod). Then, the procedure may continue to detect if the corresponding wake-up signal for the ambient IoT device 112 may be present on the channel.

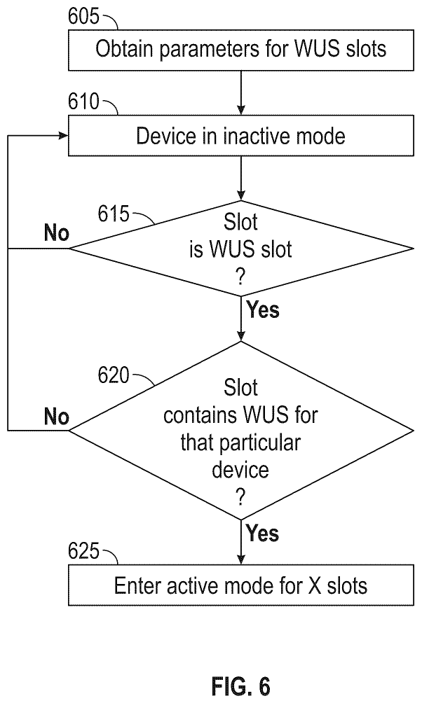

If a wake-up signal is not detected on the channel, the wake-up signal circuitry 153 may control the ambient IoT device 112 to disable its receiver, for example disabling the receiver until the next channel monitoring time and then performing the next instance of channel monitoring. If a wake-up signal is detected, the wake-up signal circuitry 152 may be configured to decode the ambient IoT device ID in the wake-up signal. Thereafter, if it is determined that the ambient IoT device ID of the wake-up signal matches the ambient IoT device ID of ambient IoT device 112, then the wake-up signal circuitry 152 may enable the receiver of the ambient IoT device 112 such that data frames, including a preamble to, may be transmitted from the ambient IoT device 112 to the gNB 101 (e.g., FIG. 6). Upon a successful reception of the preamble, the gNB 101 may send an ACK frame, which includes a RAR message, back to the ambient IoT device 112. The RAR message may include the valid TA. If the ambient IoT device 112 successfully decodes the RAR message, the ambient IoT device 112 may transmit the data request frame, including a HARQ-ACK, acknowledging the successful reception of the RAR message. The gNB 101 may send the data frame repeatedly until it receives the ACK message from A-IoT device.

FIG. 6 is a flowchart illustrating aspects of a method 600 implementing wake-up signal detection functions at the ambient IoT device. Although FIG. 6 illustrates various operations in a method of implementing wake-up signal detection functions at an ambient IoT device, according to some embodiments, embodiments according to the present disclosure are not limited thereto, and according to some embodiments, the method may include additional operations, or fewer operations, or the order of operations may vary, unless otherwise stated or implied, without departing from the spirit and scope of embodiments according to the present disclosure.

In some embodiments, the method 600 may be implement by the wake-up signal circuitry 152 of the ambient IoT device.

At operation 605, the ambient IoT device may obtain parameters for wake-up signal slots. The ambient IoT device 112 may initially obtain parameters for the wake-up signal slots (location in time/frequency, etc.) prior to channel listening. The parameters for the wake-up signal slots may be obtained by RRC signaling, and/or the parameters may be set in a configuration. The ambient IoT device has related information (e.g., time, location, etc,) to enable monitoring for the wake-up signal.

At operation 610, the ambient IoT device may be triggered to enter an inactive mode (e.g., low-power mode). After performing the initial operations (e.g., registrations, frame timing acquisition, etc.) the ambient IoT device may enter inactive mode, and may reduce consumption.

Operation 615 may involve the ambient IoT determining if the slot is a wake-up signal slot. If it is determined in operation 615 that the slot is not a wake-up signal slot (“No” in FIG. 6), then the method 600 may return to operation 610 and the ambient IoT device may remain in inactive mode. If it determined in operation 615 that the slot is a wake-up signal slot (“Yes” in FIG. 6), then the method 600 may proceed to operation 615.

At operation 620, the ambient IoT device may determine if the slot includes a wake-up signal that corresponds to the device. In the wake-up slot, the ambient IoT device may receive the wake-up signal and determine if the received wake-up signal is a corresponding wake-up signal for the device (e.g., wake-up signal configured for that particular device). In some embodiments, the determination in operation 620 may be based on an ambient IoT device ID included in the wake-up signal. If it is determined in operation 620 that the received wake-up signal does not correspond to the ambient IoT device (“No” in FIG. 6), then the method 600 may return to operation 610 and the ambient IoT device may remain in inactive mode. If is determined in operation 620 that the wake-up signal does correspond to the ambient IoT device (“Yes” in FIG. 6), then the method 600 may continue to operation 625.

At operation 625 the ambient IoT device may transition to enter the active mode. The ambient IoT device may wake up and can be active for the next set number (X) of slots, after receiving the wake-up signal. In the active mode, the ambient IoT device may monitor control channels, performs DL data reception and/or UL data transmission, perform initial access, and execute other functions that may be related to wireless communication for the ambient IoT devices.

The wake-up signal circuitry 152 may may implement a wake-up signal and/or a wake-up signal detection procedure that is suitable and/or optimal for the capabilities of ambient IoT devices, including achieving efficient and low-power wireless communication.

Referring again to FIG. 2, the multiple access circuitry 154 may be configured to implement a multiple access scheme for ambient IoT devices, including multiplexing transmissions from ambient IoT devices in a manner that may increase the received power from each A-IoT device by allowing transmission to be spread over multiple slots. In some ambient IoT systems, a relatively large number of devices may be expected to attempt (e.g., simultaneously) communication with the source (e.g., gNB, UE, etc.) after being triggered. Transmissions from such a substantial number of ambient IoT devices may result in collisions between the UL transmissions and accordingly may affect reliability of the wireless communication. To address this drawback, the multiple access circuitry 154 may implement time multiplexing of the ambient IoT transmissions.

In some embodiments, the multiple access circuitry 154 may implement a random approach for the multiple access scheme. For example, a random resource selection window may be established by a configuration (e.g., pre-configured) and/or a direct indication from the source (e.g., UE, gNB, etc.). Subsequently, ambient IoT devices may randomly select a slot from the window to perform transmissions wherein the selection of the slot may be based on multiple aspects including, but not limited to: the device priority; the payload size; type of transmission (e.g., a transmission or a retransmission); and/or the like.

In some embodiments, the multiple access circuitry 154 may implement a scheduled approach for the multiple access scheme. For example, the slot over which the device can perform its uplink transmission can be directly scheduled by the source when the device is triggered and/or by control signalling before the scheduled slot. For example, the source can include in its DL control signalling the time resources that may be used by the device or a subset of devices. This may be done by including a device ID and/or a groupcast ID to which a subset of the neighbouring ambient IoT devices belong.

In addition to time multiplexing, the ambient IoT devices may be multiplexed in the frequency domain (e.g., Frequency Division Multiple Access (FDMA)). For example, for an ambient IoT device of a particular type (e.g., device Type-C), after receiving a triggering signalling, the device may be scheduled and/or may randomly select a frequency resource (e.g., carrier or subchannel) for a transmission (e.g., UL). In another example, an ambient IoT device of another type (e.g., Type-A device, or Type-B device), after receiving a triggering signalling, the device may be scheduled and/or may randomly select the frequency resources over which the back scattered signal may be performed. Subsequently, the number of potential collisions between multiple ambient IoT devices (of different device types) may be reduced. In some cases, multiplexing schemes may have the potential to experience performance losses due to limited UL transmission power (e.g., from the backscattering) which may degrade the UL transmission reliability. To address this drawback, UL power amplification may be utilized. However, power amplification may not be suitable for some ambient IoT device of a certain type (e.g., Type-A devices) and/or may result in a relatively faster depletion of the on-board energy storage for some ambient IoT device of a certain type (e.g., Type B devices, and/or Type C devices). Therefore, extending the duration of the UL transmission over multiple slots may be utilized, in which the ambient IoT devices may perform back scattering of the DL energizing signal, and accordingly may combine the energy at the receiving side. This may also reduce the latency for ambient IoT devices that may perform energy harvesting before performing power amplification of the UL signal.

In some embodiments, the multiple access circuitry 154 may be configured to execute multiple scheduled repetitions in the time domain (e.g., Time Division Multiple Access (TDMA)). In this case, the ambient IoT devices may be scheduled multiple consecutive and/or non-consecutive resources to perform the UL TB transmission and/or retransmissions by time domain multiplexing. Employing a TDMA-based approach in some cases may increase the number of UL transmissions and may result in potential collisions between proximate ambient IoT devices (e.g., reducing transmission reliability).

In some embodiments, the multiple access circuitry 154 may be configured to execute code domain to multiplex the transmissions of multiple ambient IoT devices (i.e., Code Division Multiple Access (CDMA)). The UL transmissions of multiple ambient IoT devices may be multiplexed in the code domain, where each device may use an orthogonal code to spread its TB transmission into multiple slots in the time domain.

In cases where the multiple access circuitry 154 utilizes the code domain (e.g., CDMA) to separate the uplink transmissions from multiple ambient IoT devices, the orthogonality between the UL transmissions may enable the signals to be correctly received at the source (e.g., the gNB, UE, etc.). Accordingly, the multiple access circuitry 154 may implement Hadamard code for orthogonality between the UL transmissions. Hadamard code may be efficient (e.g., simplicity of generation, ease of transmission, no transmission of complex numbers, etc.). The Hadamard codes may be transmitted by utilizing a change in phase to represent values (e.g., 1 and −1), and may be sent using OOK which may be the modulation scheme used by the ambient IoT devices. For example, if a set number (e.g., four) of ambient IoT devices are being multiplexed, a set number (e.g., four) of Hadamard codes may be utilize. An example of the Hadamard codes that may be generated are represented in the table below (each row represents a code):

TABLE 5

| | | | | |
|---|---|---|---|---|
| Code 1 | 1 | 1 | 1 | 1 |
| Code 2 | 1 | −1 | 1 | −1 |
| Code 3 | 1 | 1 | −1 | −1 |
| Code 4 | 1 | −1 | −1 | 1 |

The Hadamard codes (as shown in Table 5) may be sent by using OOK modulation, where the codes may be represented by an ON duration and the “−1” will be represented by an OFF duration (e.g., without any back scattering). A gain may come from each ambient IoT device performing back scattering for a longer duration, thus increasing the total power that can be collected at the source.

Accordingly, the multiple access circuitry 154 may be configured to implement one or more multiple access schemes for ambient IoT devices, including a TDMA scheme, a FDMA scheme, and/or a CDMA scheme.

The multiple access circuitry 154 may be configured to perform a selection of the codes for transmission. In some embodiments, the multiple access circuitry 154 may execute a random selection in order to select the codes. For example, each ambient IoT device may randomly select a spreading code for an upcoming transmission. The selection may be performed from a set of configured (e.g., pre-configured) codes per resource pool. The number of accessible codes for the ambient IoT device may be dependent on multiple factors including system occupancy, priority, target throughput, packet delay budget, and/or the like. In some embodiments, the source (e.g., gNB, UE, etc.) may assign a set of codes to be used by the ambient IoT devices. For example, in the case of a groupcast, the source may assign a set of available codes by indicating the groupcast ID. Subsequently, the ambient IoT device within the group may perform random resource selection within the assigned set to select its code for UL transmission.

In some embodiments, the multiple access circuitry 154 may execute an assignment (e.g., from the source) to select the codes. The source may assign the code to be used by the ambient IoT device 112. Assignment may be implement implicitly, for example by indicating the code index and the target device ID that is expected to use the code. The assignment may be either dynamic and/or semi-static, such that the device may be assigned a code (e.g., once), and continue to use the same code until another assignment is received and/or a new code is dynamically indicated with a trigger for an UL transmission. The indication of the assignment may be implicit to the ambient IoT device 112. For example, the indication may be associated with the triggering DL energizing and/or control signal. If the energizing signal is sent on a set carrier (X), it may implicitly indicate to the ambient IoT device 112 to use a specific code Y for its upcoming UL transmission and/or may implicitly indicate to the ambient IoT device 112 to use a code from a specific subset of codes based on the association. The association between the UL spreading codes and the carrier frequencies for the DL energizing and/or control signal may be configured (e.g., pre-configured) per resource pool and/or it may be dynamically indicated by the source in the DL control signalling.

In some embodiments, the multiple access circuitry 154 can perform multiplexing ambient IoT device transmissions in the code domain and may increase the received power from each A-IoT device by allowing it to spread its transmission over multiple slots. Hadamard codes may be used to spread the UL transmission of ambient IoT devices (e.g., due to simplicity). In some embodiments, the multiple access circuitry 154 may be configured to execute OOK modulation for transmitting the chips of the Hadamard code. In some embodiments, the the multiple access circuitry 154 may randomly select a spreading code and/or may utilized an assigned spreading code from the source. The assignment of the spreading code by the source may be implicit (e.g., by using a specific carrier for the DL control or energizing signal) and/or explicit (e.g., by indication in the downlink control signalling).

With respect to UL transmissions from ambient IoT devices that are multiplexed in the code domain, there may be cases when a high-power imbalance may exist between UL transmissions. The orthogonality between the UL transmissions of multiple ambient IoT devices may be affected by the channel. The potential imbalance may be addressed by limiting the transmit power of the ambient IoT device in the UL domain based on the DL measurements. The multiple access circuitry 154 may be configured to perform power measurements on the received DL control signalling, and accordingly may select the UL transmission power for an upcoming transmission. The UL power amplification may be based on the measurements performed on the DL control signalling that triggered the uplink transmission. Subsequently, the measured power may be compared against a set of configured thresholds, and accordingly an UL power amplification level from a set of configured values may be selected. In some embodiments, the power amplification of the UL transmission may be indicated by the source in the downlink control signalling and may be indicated to specific devices by including the ambient IoT device ID(s) and/or by device type. Accordingly, the multiple access circuitry 154 may be configured to apply power control to address inefficiencies that may be experience with CDMA-based multiplexing, thereby improving the reliability of UL transmissions that are multiplexed in the code domain. The multiple access circuitry 154 may be configured to select an UL transmission power from a configured set based on the measurements performed on the DL control signalling that triggered the UL transmission. The source may indicate the UL power amplification level to the multiple access circuitry 154, where the indication can be specific by including a device ID and/or the indication may be sent for a specific type (e.g., Type B device).

In some embodiments, the multiple access circuitry 154 may implement functions that reduce synchronization errors that may be associated with multiplexing transmission from multiple ambient IoT devices. For example, when the code domain is used to spread the UL transmissions there may be reduced synchronization between transmissions which may subsequently impact the reliability of the UL transmissions.

The multiple access circuitry 154 may be configured to apply a timing advance on the UL transmission of the ambient IoT device 112 to reduce the synchronization errors. The timing advance may be selected by the source based on measurement performed during the initial access procedure. For example, the source may perform measurements on one or more previous UL transmissions during an initial attach phase to detect the synchronization offset that needs to be applied by the ambient IoT device 112. In some embodiments, timing advance functions may be utilized by device of a certain types (e.g., Type C devices) which may remain active in the absence of the energizing signal, because these devices may remain active and may have a better local oscillator quality. Such devices may send a preamble on a configured subset of resources to the source during the initial attach phase. Subsequently, the source may perform the measurements, and accordingly decide the necessary timing advanced offset. The timing advance offset may then be assigned a validity duration and used by the ambient IoT device 112 for the UL transmissions.

In some embodiments, the multiple access circuitry 154 may be configured to transmit a preamble sent in a DL control signal for fine tuning of the synchronization procedure. For example, the ambient IoT device 112 may attempt synchronization based on the energizing signal. Subsequently, a fine-tuning procedure may be applied in which the ambient IoT device 112 may rely on a preamble that is sent in the DL control signal. The preamble may be different from the preamble utilized by another device that is different from the synchronization source (e.g., the energizing signal may be used for synchronization and sent by the gNB whereas the control signal sent from the UE and include the preamble for fine tuning).

In some embodiments, the source may trigger random timing adjustment by the ambient IoT devices by using DL control signalling, and implementing random adjustments for different UL transmissions. For example, in multiple UL repetitions, the ambient IoT device 112 may randomly select a random adjustment for each instance of the TB. The ambient IoT device 112 may perform a randomization (e.g., Gaussian) of the timing offset to reduce the impact on the UL transmissions from the other nearby ambient IoT devices. Random selections may be triggered by the source in the DL control signal. In some embodiments, the source can use a 1-bit field to indicate to the ambient IoT device 112 to perform a random selection.

In some embodiments, the multiple access circuitry 154 may be configured to utilize code domain spreading of the UL signals for a subset of the resources that are used by device types, for example devices with better synchronization capabilities (e.g., Type C devices). Accordingly, multiple ambient IoT devices may be separated based on their synchronization capabilities, with respect to multiplexing transmission. The resources available for UL may be divided into subsets, where each subset can be used by a category (of device). Each device type with a different synchronization capability may be controlled to use a separate set of resources, thus reducing the impact from low complexity ambient IoT devices (e.g., type A devices, and type B devices) on the UL transmissions of other ambient IoT devices (e.g., type C devices).

Accordingly, some embodiments of the present disclosure implement systems and methods that may control aspects of the physical layer, including channels and/or signals, for ambient IoT devices in a manner that ensures efficient, reliable, and low-power transmission of data. Thus, the disclosed embodiments may improve the efficiency, range, and overall performance of a wireless communication network

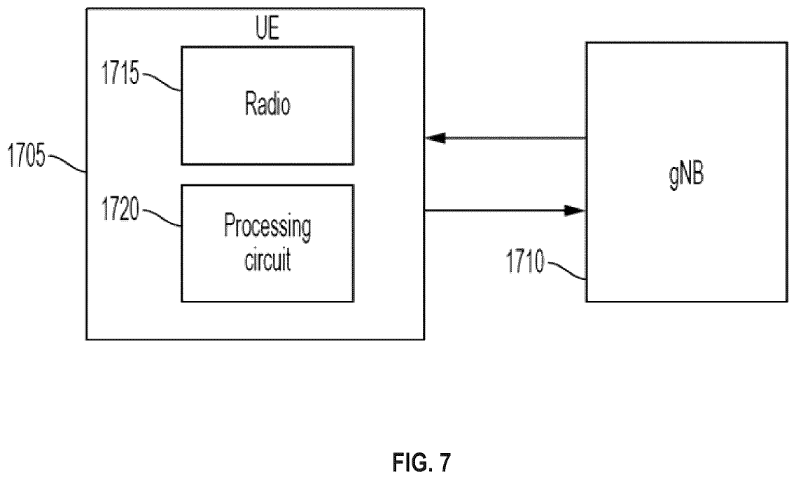

FIG. 7 shows a system including a UE 1705 and a gNB 1710, in communication with each other. The UE may include a radio 1715 and a processing circuit (or a means for processing) 1720, which may perform various methods disclosed herein, e.g., the functions and methods illustrated in FIG. 1. For example, the processing circuit 1720 may receive, via the radio 1215, transmissions from the network node (gNB) 1710, and the processing circuit 1720 may transmit, via the radio 1715, signals to the gNB 1710.

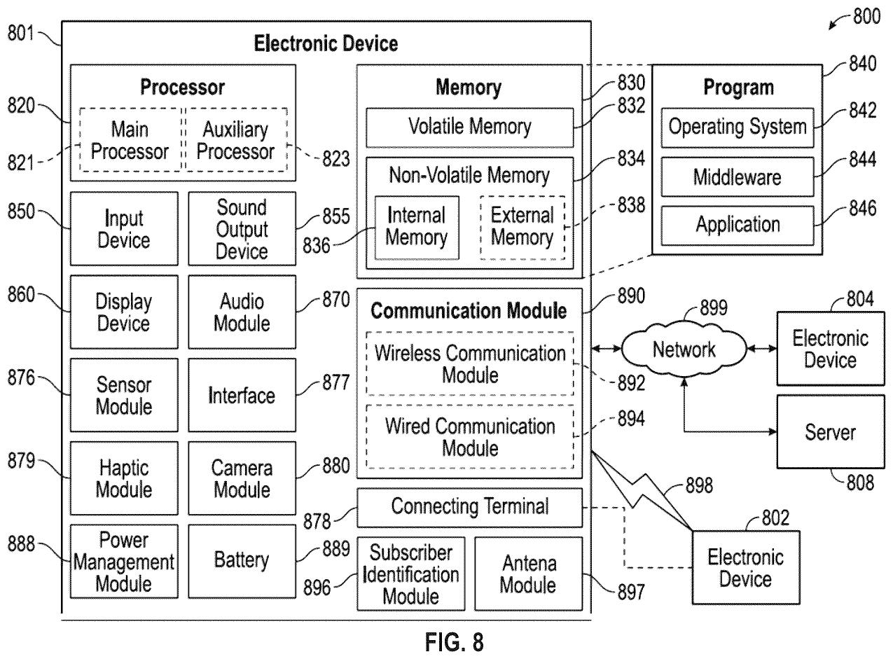

FIG. 8 is a block diagram of an electronic device in a network environment, according to some embodiments of the present disclosure.

Referring to FIG. 8, an electronic device 801 in a network environment 800 may communicate with an electronic device 802 via a first network 898 (e.g., a short-range wireless communication network), or with an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, and/or an antenna module 897. In one embodiment, at least one of the components (e.g., the display device 860 or the camera module 880) may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled to the processor 820, and may perform various data processing or computations.

As at least part of the data processing or computations, the processor 820 may load a command or data received from another component (e.g., the sensor module 876 or the communication module 890) in volatile memory 832, may process the command or the data stored in the volatile memory 832, and may store resulting data in non-volatile memory 834. The processor 820 may include a main processor 821 (e.g., a central processing unit or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or to execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890), as opposed to the main processor 821 while the main processor 821 is in an inactive (e.g., sleep) state, or together with the main processor 821 while the main processor 1821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 860 may visually provide information to the outside (e.g., to a user) of the electronic device 801. The display device 860 may include, for example, a display, a hologram device, or a projector, and may include control circuitry to control a corresponding one of the display, hologram device, and projector. The display device 860 may include touch circuitry adapted to detect a touch, or may include sensor circuitry (e.g., a pressure sensor) adapted to measure the intensity of force incurred by the touch.

The audio module 870 may convert a sound into an electrical signal and vice versa. The audio module 870 may obtain the sound via the input device 850 or may output the sound via the sound output device 1855 or a headphone of an external electronic device 802 directly (e.g., wired) or wirelessly coupled to the electronic device 801.

The sensor module 876 may detect an operational state (e.g., power or temperature) of the electronic device 801, or an environmental state (e.g., a state of a user) external to the electronic device 801. The sensor module 876 may then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 877 may support one or more specified protocols to be used for the electronic device 801 to be coupled to the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected to the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus, which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power that is supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell that is not rechargeable, a secondary cell that is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808), and may support performing communication via the established communication channel. The communication module 890 may include one or more communication processors that are operable independently from the processor 820 (e.g., the AP), and may support a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)), or via the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas. The communication module 890 (e.g., the wireless communication module 1892) may select at least one of the one or more antennas appropriate for a communication scheme used in the communication network, such as the first network 1898 or the second network 899. The signal or the power may then be transmitted or received between the communication module 890 and the external electronic device via the selected at least one antenna.

Commands or data may be transmitted or received between the electronic device 801 and the external electronic device 804 via the server 808 coupled to the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above but is instead defined by the following claims.

What is claimed is:

1. A method comprising:
receiving, by an ambient Internet of Things (IoT) device, an energizing signal;
receiving, from a first device, by the ambient IoT device, a first signal that requests a response from the ambient IoT device based on the energizing signal, wherein the first signal comprises a preamble and a data field; and
in response to the first signal, transmitting, by the ambient IoT device, a second signal comprising a preamble, a control channel field, and a data field.

2. The method of claim 1, wherein the first device comprises a reader and the energizing signal comprises a carrier wave signal.

3. The method of claim 1, wherein the first signal comprises a device identifier (ID) of a device or a group ID that maps to multiple devices.

4. The method of claim 1, wherein the control channel field and the data field are transmitted as Time Division Multiplexed.

5. The method of claim 1, wherein the preamble is modulated based on On-Off Keying (OOK) and configured for synchronization with a base station.

6. The method of claim 1, wherein the preamble in the first signal and the preamble in the second signal are different.

7. The method of claim 1, wherein the preamble in the second signal comprises a sequence based on a data rate of the ambient IoT device.

8. The method of claim 1, wherein the first signal comprises time/frequency resource allocation information for the second signal.

9. The method of claim 1, wherein the control channel field in the second signal comprises Hybrid Automatic Repeat Request (HARQ) for the second signal.

10. A method comprising:
transmitting, from a device, an energizing signal;
receiving, by the device, a first signal from a first ambient Internet of Things (IoT) device based on the energizing signal;
receiving, by the device, a second signal from a second ambient IoT device; and
multiplexing, by the device, the first signal from the first ambient IoT device and the second signal from the second ambient IoT device.

11. The method of claim 10, wherein the multiplexing the first signal from the first ambient IoT device and the second signal from the second ambient IoT device comprises at least one of: using Time Division Multiple Access (TDMA), using Frequency Division Multiple Access (FDMA), or using Code Division Multiple Access (CDMA).

12. The method of claim 11, wherein the multiplexing the first signal from the first ambient IoT device and the second signal from the second ambient IoT device using CDMA comprises Hadamard codes to spread the first signal and the second signal.

13. The method of claim 12, further comprising transmitting data encoded with the Hadamard codes using On-Off Keying (OOK) modulation.

14. The method of claim 12, further comprising spreading the first signal from the first ambient IoT device and the second signal from the second ambient IoT device over multiple slots based on a spreading code.

15. A device comprising:
one or more processors that are configured to perform:
receiving, from a reader, an energizing signal;
receiving, from the reader, a first signal that requests a response from the device based on the energizing signal; and
in response to the first signal, transmitting a second signal comprising a preamble.

16. The device of claim 15, wherein the first signal comprises a preamble and a data field.

17. The device of claim 15, wherein the preamble in the first signal is modulated based on On-Off Keying (OOK) and configured for synchronization with a reader.

18. The device of claim 15, wherein the second signal has a structure comprising: the preamble; a control channel field; and a data field.

19. The device of claim 15, wherein the first signal comprises a device identifier (ID) of a device or a group ID that maps to multiple devices.

20. The device of claim 15, wherein the device comprises an ambient Internet of Things (IoT) device.
